(19) United States
(12) Patent Application Publication
(10) Pub. No.: US 2013/0116852 A1
(43) Pub. Date: May 9, 2013

(54) DEVICE INCLUDING A MULTI-ACTUATOR HAPTIC SURFACE FOR PROVIDING HAPTIC EFFECTS ON SAID SURFACE

(71) Applicants: Esko Dijk, Eindhoven (NL); Mirela A. Weffers-Albu, Eindhoven (NL)

(72) Inventors: Esko Dijk, Eindhoven (NL); Mirela A. Weffers-Albu, Eindhoven (NL)

(73) Assignee: KONINKLIJKE PHILIPS ELECTRONICS N.V., EINDHOVEN (NL)

(21) Appl. No.: 13/809,321

(22) PCT Filed: Jun. 24, 2011
(86) PCT No.: PCT/IB2011/052776

§ 371 Date: Jan. 9, 2013

(30) Foreign Application Priority Data
Jul. 16, 2010 (EP) 10169783.7

(51) Int. Cl. G05B 11/01

(52) U.S. Cl. CPC G05B 11/01
USPC 700/301

(57) ABSTRACT

The present invention relates to a device (20) for providing haptic effects on a haptic surface. To enable a simple but accurate determination of the position, orientation and/or pose of an object positioned on the haptic surface the proposed device comprises a haptic surface (22), a number of haptic actuators (24) provided in or close to the haptic surface, a control means (26) for controlling said haptic actuators to provide a haptic effect in their proximity on the haptic surface, a sensing means (28) for sensing the actuator current and/or actuator voltage per actuator or group of actuators, and a processing means (30) for processing the sensed actuator current signals and/or actuator voltage signals by separately determining a characteristic of said actuator current signals and/or actuator voltage signals and generating pressure indications from the determined characteristic, said pressure indications indicating the amount of pressure at the respective actuator or group of actuators.

### FIELD OF THE INVENTION

The present invention relates to a device for providing haptic effects on a haptic surface. Further, the present invention relates to a method for providing haptic effects on a haptic surface. The present invention relates further to a corresponding computer program for controlling said device.

### BACKGROUND OF THE INVENTION

The present invention is in the area of tactile/haptic actuation surfaces (e.g. blankets, mattresses, exercise mats, sheets, cushions, etc.). In this context, the term “haptic surface” shall be understood as a surface that has integrated tactile/haptic actuators in order to convey haptic (tactile) stimuli to an object or user in contact with the surface. Such surfaces, hereinafter called “haptic surface”, can be used for different applications, such as enhancing a movie experience with haptic/tactile effects, haptic effects used for a guided breathing exercise, haptic effects for a relaxing/massaging experience and user feedback/providing information to a user via the sensory channel of touch, e.g. a sports mat that provides haptic feedback related to exercises being done. It shall be noted that the present invention is not only relevant for applications directed to a person or user, but that there are also applications directed to non-living objects. Hence, whenever the terms “user” and “object” are used hereinafter, they shall generally be understood broadly as including living beings and non-living objects, as far as such an understanding is reasonable.

A general problem for such haptic surfaces is that the device (containing a haptic surface as one of the parts) can only provide an optimal stimulation to a user lying-on/sitting-on/being-in-contact-with the surface, when the device knows how (in what position/orientation/pose) the user is on the haptic surface. Size and length of the body may play a role here as well. For instance, once the user position/pose is known with some precision, it becomes possible to apply more targeted haptic patterns e.g. to stimulate specific muscle groups or actuate a ‘shiver down the spine’ in an application of a massage mat.

To solve this problem, one straightforward solution is to use multiple pressure sensors or body contact sensors. A second straightforward solution is to instruct a user (e.g. via a manual) how to sit/lie on the device or make the shape of the device such that it is obvious how to use it (e.g. a jacket). However, the latter solutions still have the problem that they do not automatically adapt to the user if 1) the user has a different body shape/size than expected, or 2) the user decides to use the device anyway different than intended or 3) the user is not fully aware of the correct usage of the device.

DE 102007051411 A1 describes a multi-actuator massage mat system using haptics. Specifically it uses frequencies in the 10-100 Hz range. It is particularly described in an embodiment in which the current to a vibration motor is measured, in order to detect whether or not this motor currently causes a resonance of the human body part close to the motor. The text describes that being in resonance induces a ‘significant’ motor current change. This effect is only used for the benefit of finding the specific body part resonance frequency but other purposes are not described. Measuring motor current is described as a cheaper alternative to fitting accelerometers next to each actuator to detect resonance conditions.

### SUMMARY OF THE INVENTION

It is an object of the present invention to provide a device and a method for providing haptic effects on a multi-actuator haptic surface which enable a simple but accurate determination of the position, orientation and/or pose of an object positioned on the haptic surface or in any other way exerting pressure on said haptic surface. It is a further object of the present invention to provide a corresponding computer program for controlling said device.

In a first aspect of the present invention a device is presented that comprises:

a haptic surface,

a number of haptic actuators provided in or close to the haptic surface,

a control means for controlling said haptic actuators to provide a haptic effect in their proximity on the haptic surface,

a sensing means for sensing the actuator current and/or actuator voltage per actuator or group of actuators,

a processing means for processing the sensed actuator current signals and/or actuator voltage signals by separately determining a characteristic of said actuator current signals and/or actuator voltage signals and generating pressure indications from the determined characteristic, said pressure indications indicating the amount of pressure at the respective actuator or group of actuators.

In a further aspect of the present invention a corresponding method is presented comprising the steps of:

providing haptic effects on a haptic surface by use of a number of haptic actuators provided in or close to the haptic surface,

controlling said haptic actuators to provide a haptic effect in their proximity on the haptic surface,

sensing the actuator current and/or actuator voltage per actuator or group of actuators,

processing the sensed actuator current signals and/or actuator voltage signals by separately determining a characteristic of said actuator current signals and/or actuator voltage signals and generating pressure indications from the determined characteristic, said pressure indications indicating the amount of pressure at the respective actuator or group of actuators.

In still a further aspect of the present invention a corresponding computer program for controlling the device is presented.

Preferred embodiments of the invention are defined in the dependent claims. It shall be understood that the claimed method and the claimed computer program has similar and/or identical preferred embodiments as the claimed device and as defined in the dependent claims.

A disadvantage of using the motor current as a means of sensing resonance conditions, as proposed in the above cited DE 102007051411 A1, has no ability to provide a simple but accurate determination of the position, orientation and/or pose of an object positioned on the haptic surface or in any other way exerting pressure on said haptic surface (as opposed to a device without sensing where a user e.g. has to configure the haptic effects manually to his/her body shape and position). To overcome this disadvantage and obtain knowledge about the position, orientation and/or pose of an object positioned on the haptic surface or in any other way exerting pressure on said haptic surface easily without much additional hardware, it is an idea of the present invention to re-use the existing haptic actuators to perform the object (e.g. a user) sensing task also, besides the regular task of haptic actuation that these actuators have. Instead of many separate sensors, then only a minor amount of extra hardware is needed to turn the actuators into sensors as well. This amount of hardware is, in preferred embodiments even independent of the total amount of actuators present in the haptic surface. In this context, haptic actuators shall be understood as actuators that are able to convey a haptic include actuators that are able to convey haptic (tactile) stimuli to an object or user in contact with the haptic surface including actuators that are able to provide vibration effects.

It has particularly been recognized that the rotation speed of an actuator as commonly used in such a haptic surface is, when applying a fixed supply voltage to it, dependent on the amount of pressure (force) applied to the actuator externally, i.e. more applied force increases the rotation speed. Hence, rotation speed changes occur for several actuators when e.g. a user sits on a haptic actuation surface and several actuators are pressed down. These rotation speed changes can, for instance, be observed as small variations in the current drawn by the actuator (and also as voltage swings on the supply leads on the actuator).

Hence, the main idea of the present invention is to evaluate a characteristic of the sensed actuator current signals and/or actuator voltage signals (in the following also referred to as “actuator currents” and “actuator voltages”, respectively) to obtain information about the pressure exerted onto the respective actuators. Various characteristics may be usable for this purpose, in particular the amount, phase and/or frequency of the current drawn by the actuators and/or the amount, phase and/or frequency of the voltage applied to the actuators. Other characteristics are the dominant frequency of the current and/or /voltage signals or even two or more dominant frequencies in the current and/or voltage signals.

Finally, a pressure indication is generated from the determined characteristic which provides an indication about the amount of pressure at the respective actuator or group of actuators, i.e. provides at least an indication if any pressure is exerted on the actuator or group of actuators (e.g. due to a user positioned above the actuator or group of actuators) or if no pressure is exerted.

Since this current or voltage signal, which will also be called small variation signal, may be quite noisy in practice, it is proposed according to a preferred embodiment of the invention to separately—for each actuator or group of actuators—determine a dominant frequency in said actuator current signals and/or actuator voltage signals and to use the found dominant frequency each time to determine the amount of pressure at the respective actuator or group of actuators. In other words, the higher the dominant frequency, the higher the rotation speed of the actuator and the higher the applied pressure. The pressure indication is then generated from the determined dominant frequency.

According to a preferred embodiment said processing means is adapted for determining the frequency spectra of the sensed actuator current signals and/or actuator voltage signals, finding a maximum peak in said frequency spectra in a predetermined frequency range and generating said pressure indications from said maximum peaks, wherein the amount of pressure is a assumed to be higher the higher the frequency of a maximum peak is. Preferably, per actuator the above mentioned small variation current/voltage signal is measured, the frequency spectrum is determined there from, and then a maximum peak is determined in the spectrum in an expected frequency range. This frequency range is generally depending on the type of actuator. The frequency value of the found maximum peak is then used as an indication of the amount of pressure exerted on the actuator.

According to a further embodiment said processing means is adapted for determining that an object is exerting pressure on said haptic surface by determining if the percentage of actuators, whose pressure indications indicate an amount of pressure above a predetermined pressure threshold, is above a predetermined actuator threshold. Said pressure threshold may be determined in advance, depending on the kind of application, the type, number and arrangement of actuators and the object itself, i.e. it may be set to an individual value for each device, object and application. The same holds generally for the actuator threshold indicating a percentage (or number) of actuators, which is used by the processor for this check, since, for instance, for a small object the percentage of actuators above a pressure threshold will be lower than for a large object.

Preferably, the processing means is adapted for determining the position, orientation and/or pose of an object exerting pressure on said haptic surface, in particular being positioned on the haptic surface. This is particularly possible when the pressure information is collected over multiple actuators and, further preferably, combined into one coherent model, according to which said processing means is adapted for determining the position, orientation and/or pose of an object exerting pressure on said haptic surface by use of a model representing the object. Again, the model generally depends on the kind of application, the type, number and arrangement of actuators and the object itself.

According to another embodiment said sensing means includes a comparator for comparing an actual actuator current or voltage, respectively, with a reference current or voltage, respectively, and for issuing the difference as said actuator current signal or actuator voltage signal, respectively. This provides a simple implementation for obtaining the actuator current signals or actuator voltage signals.

There are various embodiments for performing the measurements of the actuator current signals or actuator voltage signals, respectively. In one preferred embodiment said control means is adapted for controlling selected or all actuators sequentially or in groups in parallel to provide a haptic effect. At each actuator which is controlled to provide a haptic effect a measurement of the actuator current or actuator voltage is performed. Parallel measurements of several actuators require more hardware, but less time.

Some time can also be saved in an embodiment according to which said control means is adapted for subsequently controlling actuators to provide a haptic effect, at which it is known or suspected that an object exerts pressure on said haptic surface in the proximity to said actuator. This can particularly be used if details of the object and its likely position on the haptic surface can be estimated in advance, as proposed in a further embodiment according to which said control means is adapted for controlling actuators to provide a haptic effect based on knowledge about the shape and/or position of an object exerting pressure on said haptic surface.

Even more time can be saved in an embodiment according to which said control means is adapted for controlling actuators to provide a haptic effect only at positions where parts of the object, in particular significant parts of the object, are assumed to be positioned and wherein the processing means is adapted for estimating the position, orientation and/or pose of the other parts of the object.

In still another embodiment said processing means is adapted for performing a predetermined number of pressure measurements, a predetermined sequence of pressure measurements and/or amounts of pressure at predetermined actuators and interpreting them as a command or information. For instance, if a user presses two times quickly in sequence at a particular actuator (or known actuator position), this may be interpreted as an instruction to increase (or decrease) the stimulation by this actuator.

Many types of haptic actuators exist. Preferably, any type of vibration motor can be used for the actuators according to the present invention. Such vibration motors are, for instance, known from WO 2010/036016A2 or from www.vibrationmotors.com. Particularly, coin-type vibration motors or eccentric rotating mass (ERM) vibration motors have shown good results when used in a device and method according to the present invention.

The present invention can be used in many applications. The claimed device may, for instance, be implemented as a relaxation or massage device, a relaxation or meditation training system or a breathing guidance or paced breathing system. Further, the claimed device may be coupled to a TV or home cinema entertainment system, i.e. generally an additional display/sound system may be required, which is probably not integrated in the same device as the haptic surface, to provide haptic effects to a user viewing a movie. Further applications are, however, not excluded.

### BRIEF DESCRIPTION OF THE DRAWINGS

These and other aspects of the invention will be apparent from and elucidated with reference to the embodiment(s) described hereinafter. In the following drawings

FIG. 1 shows a diagram illustrating a possible application of the invention,

FIG. 2 shows schematic block diagram illustrating an embodiment of the device according to the present invention,

FIG. 3 shows a diagram illustrating the effect exploited according to the present invention,

FIG. 4 shows an exploded view of a vibration motor,

FIG. 5 shows a mass-spring-damper model for explaining the behavior of an actuator,

FIG. 6 shows a flowchart explaining an embodiment of the method according to the present invention,

FIG. 7 shows a circuit diagram of the electronics used in an embodiment of the device according to the present invention,

FIG. 8 shows an embodiment of the arrangement of a plurality of actuators according to the present invention,

FIG. 9 shows a user positioned of the arrangement shown in FIG. 8,

FIG. 10 illustrates which actuators are affected by the user,

FIG. 11 shows a frame representing an estimate of a user position and orientation relative to the arrangement of actuators, and

FIG. 12 shows the frame overlying the user as shown in FIG. 10.

### DETAILED DESCRIPTION OF THE INVENTION

FIG. 1 illustrates first a possible use of the present invention, also called the Feel 3D concept. Shown is a couch 10 combined with a flexible blanket 12 that a user or family can easily spread on the couch 10 or a chair. The blanket 12 contains a matrix of small vibration motors (generally, of haptic actuators) 14, which may be of the type found in mobile phones. For users sitting on the couch 10, the blanket 12 can render effects on the upper legs, butt, and back and also on the neck if a user is sitting in a ‘lazy’ low position. Further options are to wrap the blanket around yourselves e.g. if you are watching alone on the TV set 16. Alternatively, the haptic actuators 14 could also be integrated directly into the couch 10 underneath the surface on which users are sitting and/or leaning.

There are different ideas to create haptic effects with such a blanket 12. For example, if an object in the movie approaches towards the viewer, the viewer could feel the impact of the object first in his/her legs and a fraction of a second later in the butt/back. Such a kind of suggested motion pattern could even depend on the angle the object is coming from in the movie. Further, the impact of gunshots, explosions, kicks, shaking, breaking glass, moving objects, etc. can be mapped onto specific effect patterns on the blanket 12. Such events are also more common in a movie than the event of something flying towards the camera viewpoint.

Still further, when a group of at least two people is watching TV as shown in FIG. 1, moments of shared excitement of the viewers, e.g. in a sports match, comedy movie, other movie, or other show, can be automatically detected, e.g. by the TV set 16 including respective detection means, such as commonly available as “computer vision”. Further, the amount of movement could be used as an alternative indicator. When these moments are detected (based on audio, computer vision and/or motion sensor input), a haptic actuation is switched on in the couch 10 or chairs (or the blanket 10, respectively) to strengthen the moment of excitement further. The TV 16 may for this purpose also comprise control means for controlling the actuators 14 accordingly.

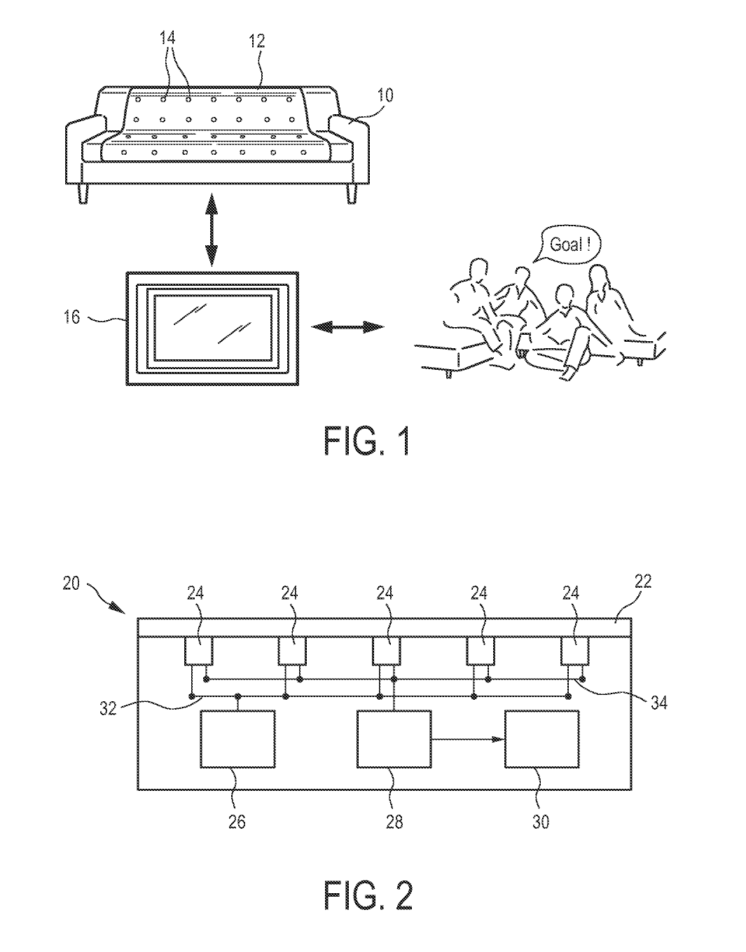

FIG. 2 schematically shows a device 20 according to the present invention. Said device 20 may, for instance, be a blanket as shown in FIG. 1 or a mattress, on whose surface haptic effects can be provided. The device 20 comprises a haptic surface 22, a number of haptic actuators 24 provided in or close to the haptic surface 22, a controller 26 for controlling said haptic actuators 24 to provide a haptic effect in their proximity on the haptic surface 22, a sensing unit 28 for sensing the actuator current and/or actuator voltage per actuator or group of actuators, and a processor 30 for processing the sensed actuator current signals and/or actuator voltage signals by separately determining a characteristic of said actuator current signals and/or actuator voltage signals and generating pressure indications from the determined characteristic, said pressure indications indicating the amount of pressure at the respective actuator or group of actuators. For control of the actuators 24 by the controller 26 a control line 32 is provided, and for sensing the actuator current and/or actuator voltage by the sensing unit 28 a sensing line 34 is provided.

Although the controller, sensing unit 28 and processor 30 are shown in FIG. 2 as being incorporated within the device 20, this shall not be understood as a limitation such that these units must be physically enclosed by the outer surface (or hull) of the device 20 (e.g. with the blanket or mattress), but these units can also be physically arranged outside of or at the outer surface of the device 20, e.g. be arranged on the upper surface at a position accessible to a user.

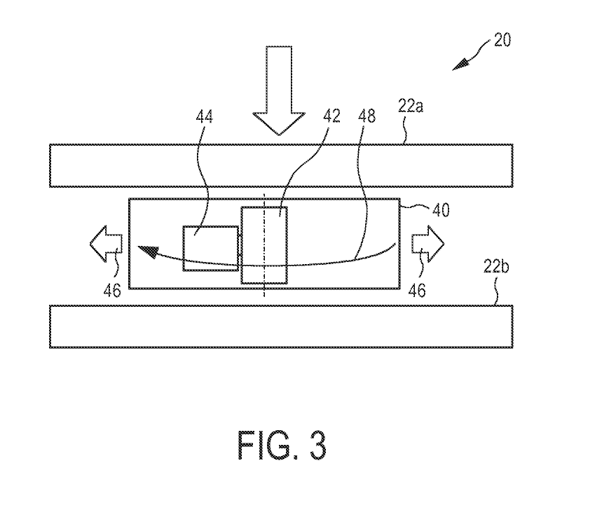

FIG. 3 schematically shows how an actuator, here a vibration motor 40, is mounted in a device 20, e.g. a massage blanket. The vibration motor 40 is arranged between (upper and lower) haptic surfaces 22a, 22b and generally comprises a rotor 42 and a mass 44 eccentrically arranged with respect to the rotation axis 46 of the rotor 42. This mass unbalance inside the vibration motor 40 causes it to vibrate in the vibration direction 48 when a voltage is applied. The vibration frequency and amplitude depends on the applied voltage amongst others.

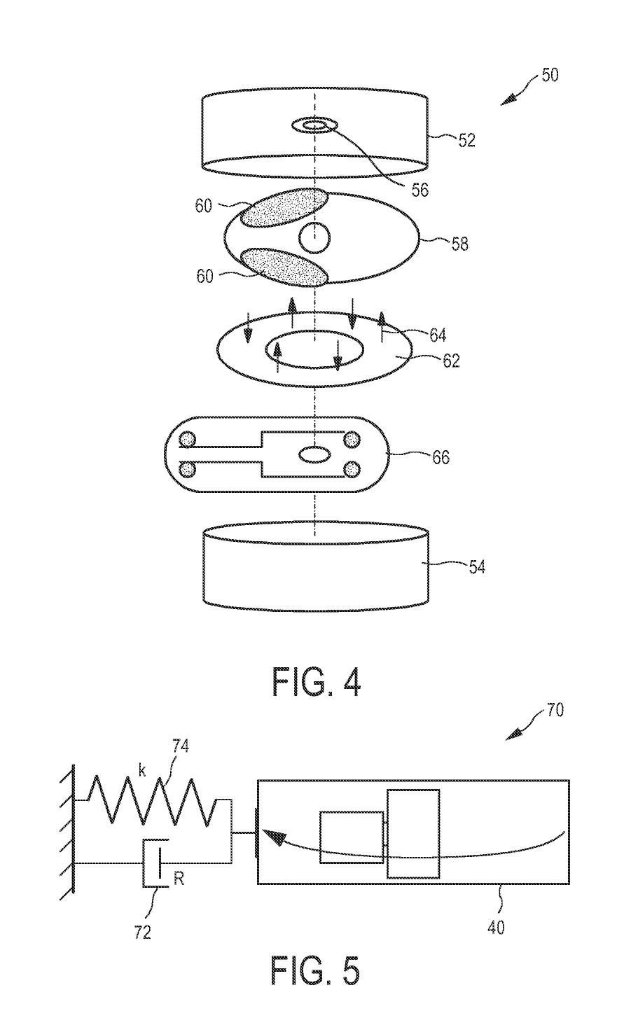

Various types of actuators, e.g. coin-shaped vibration motors as disclosed in the above mentioned WO 2010/036016A2 can be used as haptic actuators according to the present invention. One particular example of a type of ERM vibration motor is the “pancake shaped” or “coin shaped” motor as disclosed at http://www.vibratormotor.com/coin-table.htm. FIG. 4 shows in an exploded view the main elements of such a motor 50. It comprises a top lid 52 and a lower lid 54 (both e.g. of tin or Fe) arranged around a shaft 56. The top lid 52 squeezes against the lower lid 54, which short-circuits the vertical magnetic field. In this embodiment the motor 50 further comprises a rotor 58 with two excentrically arranged coils 60 which are separated by, for instance, 120°. Further, a magnet ring 62 with a vertical magnetization with 3 magnetic north poles and 3 magnetic south poles is provided for generating a magnetic field indicated by magnetic field lines 64. Finally, a connector foil 66 including connection wires and brush contacts are provided.

In practice, the way such a vibration motor is mounted in a product partly determines the level and frequency of the vibration. Referring to FIG. 3 again, a pressure P (e.g. from a user sitting or lying on the massage blanket, i.e. on a haptic surface 20a) causes the motor 40 to be squeezed in-between the mounting materials (e.g. surfaces 20a, 20b) at both sides.

The physical model of this situation can be approximated by an ideal mass-spring-damper model 70 as illustrated in FIG. 5, in which the entire vibration motor 40 is seen as the mass. In this case the mass is also driven (moved) by an external force caused by the applied voltage onto the vibration motor 40. This force is not shown in FIG. 5. In a practical mounting in which it is important to feel the vibration effect, the damping R of a damper 72 will typically be low, such that the main physical effect will be determined by the spring constant k of the spring 74. The spring constant is dependent on external factors including the pressure P applied on top of the motor as in FIG. 3. The higher the pressure, the stiffer will be the spring 74 in the model of FIG. 5 and the higher will be the spring constant k.

The equation for the natural frequency of this system is:

ω_{d}=sqrt(ω₀²−α²)

where ω₀ is the natural frequency of the undamped system given by

ω₀=sqrt(k/m)

with k the spring constant and m the mass, and a damping-induced term

α=R/(2m).

In the situation that more pressure is applied, k increases while m remains constant and R increases slightly, the net effect is that ω_{d} increases. So the natural frequency of the system increases and (given the same driving voltage) the frequency of vibration coming from the motor also increases.

Next, the principle underlying the present invention shall be explained by explanation of a preferred exemplary embodiment. The rotation speed of the motor (actuator), when applying a fixed supply voltage to it, is dependent on the amount of pressure (force) applied to the motor externally. This force includes pressure applied with a finger or other body part and the amount of clamping force that is used to keep the vibration motor in its place, i.e. how tightly the vibration motor is fastened to a substrate. More applied force and tighter clamping will increase the rotation speed of the motor. The lowest rotation speed is achieved for a motor free-floating in space, attached only to its power supply wire.

The rotation speed changing with pressure occurs also when a user sits on a haptic actuation surface and several actuators are pressed down, or the user leans against actuators. The surface material should be designed soft enough, such that the forces resulting from user position or position change can reach the actuator.

The varying speed of the rotation of the motor produces (through coils/magnets) a counter-electromotive force which can be observed as a small, cyclical current changes over time in the average vibration motor current consumption. Also, on the voltage such a periodic signal can be observed. However, this small variation signal may be quite noisy in practice.

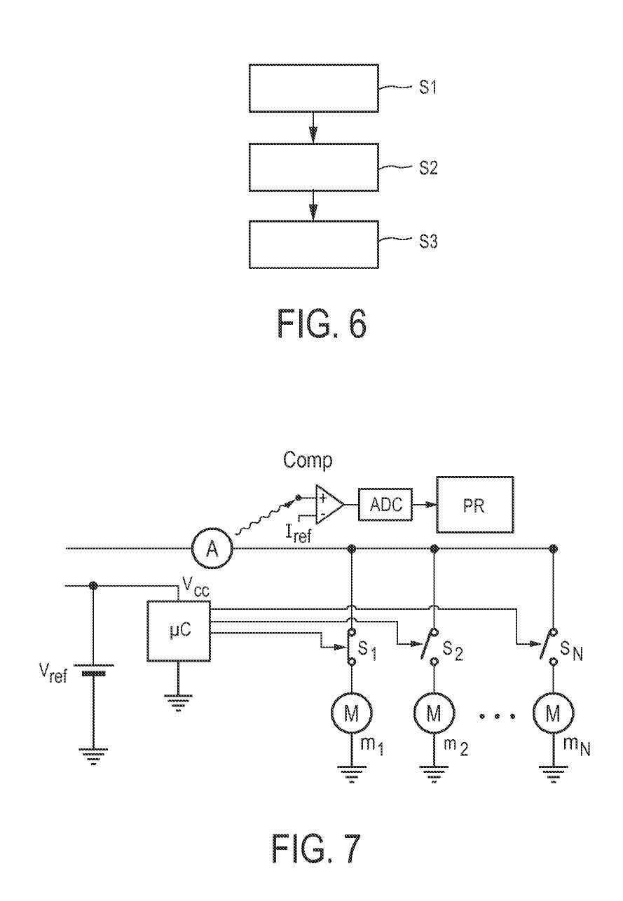

To detect pressure information from the current/voltage variation signal it is proposed in an embodiment according to the present invention, as illustrated in the flow chart shown in FIG. 6, to perform the following steps (preferably per activated motor):

Step S1: Calculate a frequency spectrum of a short time interval of the above mentioned small variation current/voltage signal.

Step S2: Find a maximum peak in the spectrum, in an expected frequency range (range to choose is depending on the type of actuator).

Step S3: Use the frequency of the maximum peak as an indication of the amount of pressure exerted on the actuator. The higher the peak frequency, the more pressure is applied.

The steps S1 and S2 can of course be replaced by another method for dominant frequency estimation.

On the electrical/hardware design level, there are many ways to efficiently implement measurement and processing of the current/voltage variation signal into a working system. As an example, one embodiment is provided in FIG. 7. This simplified circuit diagrams shows a voltage source V_{ref}, micro-controller μC that controls a number of N motors m₁, m₂, . . . , m_{N}. Motors M, current meter A and digitally controlled switches S₁, S₂, . . . , S_{N} are also shown. In the shown situation, the micro-controller μC has closed the switch S₁ for motor m₁ while all others switches are open. The current meter A measures the current fluctuation, the comparator Comp compares the measured value to the stable reference value Iref, and the difference (i.e. the small current variation signal) is digitized by the analog-digital converter ADC and sent as binary data to processing unit PR that executes the method steps as explained above and as shown in FIG. 6. In this shown situation, the amount of pressure exerted on m₁ is detected. In a next time step, the process is repeated for motor m₂, etc.

Practical measurements with an ERM motor as actuator have shown that the application of finger pressure made the dominant frequency peak go up by about 100-200 Hz. By pressing harder or less hard, the frequency peak could be shifted at will in the range around 100-450 Hz.

The embodiment described above is just one strategy of how the pressure measurements could take place. A number of different strategies of activating the haptic actuators (and detecting if pressure is applied and, possibly, which amount of pressure is applied) are available.

According to a first strategy, which can be used in the embodiment explained above, actuators are activated one-by-one in a sequence. With each activation the actuator supply current or voltage variation signal is measured by one (single) hardware component e.g. measured by an ADC and then processed digitally. This procedure takes an amount of time linear with the number of actuators.

According to a second strategy only selected actuators at strategic positions are activated one-by-one. This will save time compared to the previous strategy. The idea is to actuate just enough actuators to determine the user position to a required degree of accuracy.

According to a third strategy groups of actuators are actuated together. If there are multiple current/voltage variation signal measurement units in hardware, they can work in parallel on groups of actuators. For example, with the system explained above N actuators can be measured sequentially and the system can be replicated K times. Then N×K actuators can be measured in N time steps, at the cost of extra measurement hardware.

According to a fourth strategy all actuators are activated together. This will work e.g. if each actuator has its own current/voltage variation signal measurement hardware.

According to a fifth strategy the user position/pose identification process can be performed during the application of haptic stimuli in a working system. E.g. in a relaxation system, the user starts having a relaxation session. During the first 30 seconds of the session, the haptic actuations patterns (that are anyway applied to the haptic surface, following a relaxation program) are stored and the results from the current/voltage variation signal measurements are also stored. If enough different actuation patterns have been applied in this time period, it could be possible to reconstruct the pressure values per actuator. However, this may require some complex computations in order to find the most likely ‘distribution of pressure values on the haptic surface’ that led to the observations (current/voltage variations over time). For example, a Bayesian network could be used for this or Maximum-Likelihood Estimation methods (as, for instance, disclosed in Jerry M. Mendel and C. S. Burrus, Maximum-Likelihood Deconvolution: A Journey into Model-Based Signal Processing, Springer, 1989). On the other hand, this strategy could be used to update user position/pose information all the time, during a haptic experience.

According to a sixth strategy a body contour tracing strategy is proposed. This could work similar to a game of Minesweeper which is known for the Windows OS. First actuators at likely locations where a user body is located are probed, and then it is tried to trace the contours of the body based on available information up to now. Detailed probing in areas where no user body is located or where for sure the user is located is avoided to save time.

According to a seventh strategy for a blanket using a matrix of N×M actuators, at the beginning of the massage session the system could start first by activating a “wave” during which M actuators would be activated line by line. For each line, the system will store in memory the positions of the actuators for which their frequency indicates pressure. Once the wave passed through the entire blanket, the system has in the memory an image of the user's body based on the position of those actuators which indicated pressure.

According to an eighth strategy, as a faster alternative, for a blanket using matrix of N×M actuators, at the beginning of the massage session the system could activate a wave from both directions (vertically). The waves should be activated only until they reach the feet and respectively the head and shoulders of the user. The differentiation between feet vs. head and shoulder areas can be rather easy made taking into account the amount of actuators that will register pressure (for feet/heels/legs there should be significantly less actuators indicating pressure than for shoulders). Once knowing the location and dimensions of the shoulders, the dimension of rest of the body can be estimated.

According to a ninth strategy, for the case where the massage mat is intended to be used also to cover the user, the upper/front part of the body cannot be sensed using the methods described above. However, the lower/back part of the body can be sensed as previously described and the upper/front body can be deduced by mirroring the image of the lower/back side of the body to determine which actuators should be actuated.

The strategies introduced above, could be negatively impacted by a user moving a lot during the calibration phase (i.e. the phase where the haptic surface is used solely to detect the user's position and pose). For a relaxation system where a user is supposed to lie still most of the time, an initial calibration may be enough. For some applications, a few re-calibrations during the course of an experience may be acceptable.

The estimation of user position and pose makes use of the ‘coherent model’ mentioned. The purpose of the model is only to enable the estimation process. Different levels of complexity of models can be distinguished:

1. Simple models just for detecting presence of a user on a surface—not position or orientation.

2. Models for estimating user position and orientation only, assuming one typical or required user pose. For example, the assumed pose could be lying down on a mat on the back. This type of model only assumes a user is lying down on his/her back and cannot correctly handle other cases e.g. a user sitting.

3. Models for estimating position, orientation and pose together. This type of model could also handle other cases e.g. a user sitting, standing, or taking position for doing push-up exercises.

The complexity of the model also depends on the number of supported poses. The more poses are supported, the harder the model is to implement robustly.

One example model for detecting presence of user on surface (simplest case) is as follows. Assume a product which is a massage mat with N_{MOT}=40 vibration motors, and it is turned on. The user had a massage session and now steps off the product. A ‘wave’ pattern of massaging is just being given by the product after that event, and the current/voltage recordings of all motors have been done in parallel and pressure estimated according to the present invention. The number of motors N_{P} is counted which measured a frequency greater than a predefined threshold T. If the fraction N_{P}/N_{MOT}>R e.g. R=0.4, the system decides that a user is lying on the mat. Otherwise the system decides that no user is lying on the mat.

The model can be seen to consist of the count N_{P}, threshold T, and fraction R. Based on this information the product could take action e.g. reduce actuation for a while and then turn off after a minute.

Next, a model for estimating user orientation and position only shall be explained. Assume a product (device) which is a massage mat with N_{MOT}=60 vibration motors, arranged in a 6×10 grid. The model includes a representation in the memory of the device of a 2D matrix of 6×10 pressure values. These pressure values are based on measured frequency as explained above.

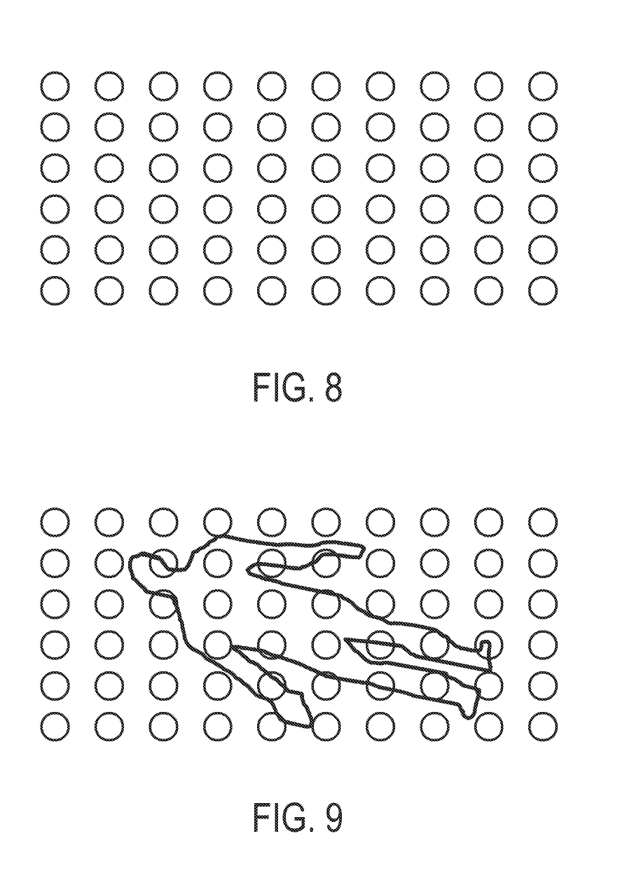

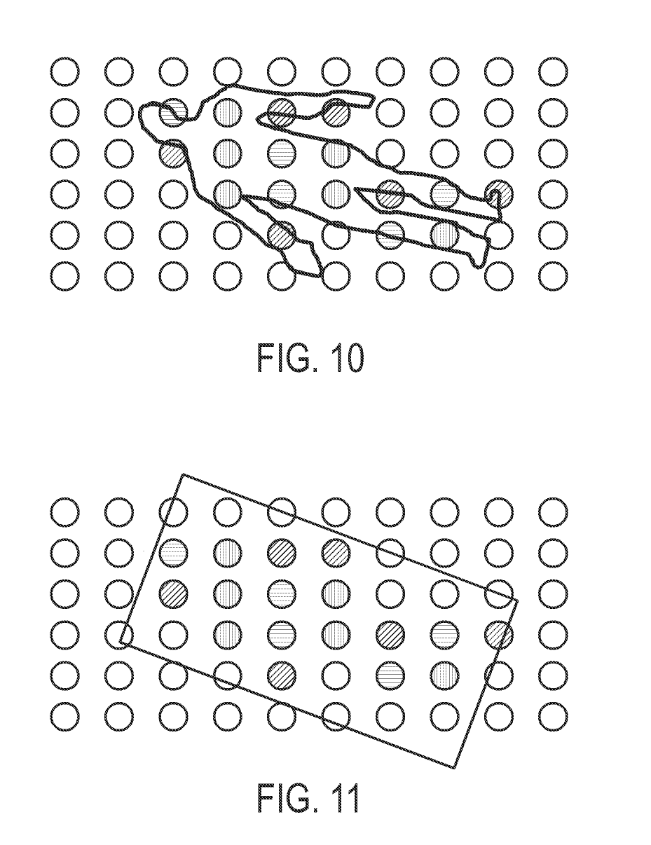

The motor layout and also the in-memory model can be sketched as shown in FIG. 8. A small user lies down on the product as shown in FIG. 9. If the measured pressure values are roughly represented as marking code, the result as shown in FIG. 10 is obtained, in which dots filled with vertical lines means high pressure, dots filled with horizontal lines means medium pressure, dots filled with diagonal lines means some (small) pressure, and unfilled (white) dots means no pressure detected.

Now the model could represent a user simply as a box (rectangle) as shown in FIG. 11. The system can try to fit a box optimally around the values where pressure is detected. Because the granularity of 6×10 motors evenly spread over a larger surface is quite low, this system does not detect the head side (left or right) of the user. Instead, it is assumed that the user puts the head at the correct ‘head end’ of the massage mat.

The estimation could be implemented as a standard numerical optimization problem with 5 degrees of freedom/variables: box (X,Y) middle position coordinate, box orientation (1 rotation angle), box length and box width. The error function in the numerical optimization may consist of two parts which each have a weighted contribution to the error function, e.g. the average deviation of the measured pressure from a pressure value P (which may be set to the maximal possible pressure that can be determined with an actuator, or e.g. 80% of maximal possible pressure) of all actuators located inside the virtual box, and the average deviation of the measured pressure from zero pressure of all actuators located outside the virtual box. Of course, more complex models are well possible. Instead of a box, a human-body-shaped template shape could be used for more accurate results.

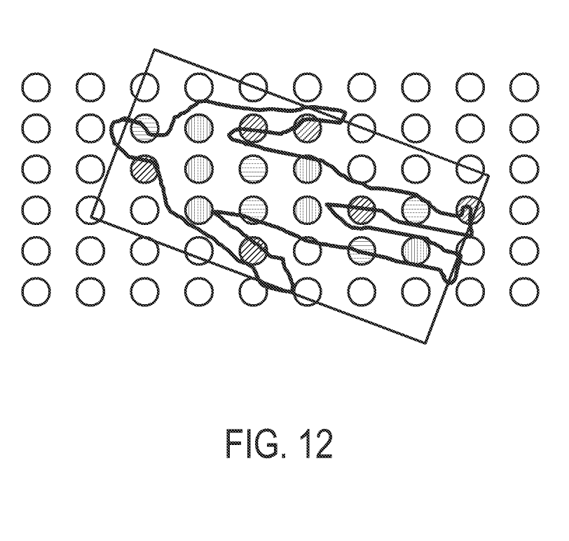

FIG. 12 shows the estimated box superimposed on the original contour plot of the user's body. The box turns out to be a reasonably accurate estimate, useful for adapting the haptic stimulation optimally towards the current user's body size, length and position/orientation.

It should be noted that for a more accurate detection of body position including position and orientation of body parts (legs, and arms) a more fine grid of actuators would be helpful. On the other hand, it is not a necessity. With a more advanced type of model (e.g. Bayesian probabilistic based with a human body shape model instead of a simple box) maybe also the positions of legs and arms can be resolved.

An extension of the previous model could be to allow multiple poses of the human body, for example lying down, sitting, kneeling, or specific exercise positions (e.g. from yoga or fitness). Such a model is more complex. The key additional task for handling pose in a model is classification. Each type of human pose to be detected can be considered a class (see above list), and there could also be classes for “User absent”—no-one is on the mat, and “Unknown/other”—a user is present but not in a recognizable pose.

To get a good classifier for pose, a good set of features are needed as input to the classifier. Possible features to use are:

1. Number of detected regions of pressure. Known algorithms e.g. from computer vision can be used to detect groups of actuators on which non-zero pressure is detected, e.g. by applying the algorithms to the in-memory 2D representation of pressure values. For example, in FIGS. 8-12, there is only one region corresponding to the user body. If the user is doing an exercise position (e.g. yoga standing with hands on the mat) two or three regions may be found.

2. Position, orientation, or width/length or surface size of a bounding box fitted to each detected region (according to the previous model as introduced above or another method). Instead of bounding “box” other shapes could be fitted, circular, ellipsoid, etc. Further, more than one bounding shape could be fitted.

3. Average pressure per region, or overall average pressure.

4. Fraction of actuators (out of total) on which pressure is measured.

5. Surface size of each region.

6. Determined relative distances between the regions.

According to another embodiment of the present invention during a massage/haptic stimulation session, a pressure on the mat deliberately applied by the user (e.g. a short strong press at a certain location, or 2 successive strong presses) may activate an extra function. Typically this function would be to increase strength of the haptic actuation at the point indicated by the user. This can be used e.g. to massage extra some body part where the user wants to have a stronger massaging effect.

Still further, in an embodiment the user position estimation process can be used to identify the user. For example, if a haptic massage or relaxation device is owned by a one-couple household (two persons) where the two persons have different height and weight, the calculated pressure values can be used as an indication which of the two users is lying down on the haptic surface. A first outcome of the estimation process according to the invention is the approximate length of the user and a second outcome that can be derived from the multiple estimated pressure values is an estimated average pressure value that the user body exerts on the haptic surface. If the length, or the weight, or both, differ enough from each other, the system could classify the current user as either user 1 or 2. A benefit of this implicit user detection is that personalized massage preferences that have been set earlier, can be automatically retrieved again from memory to provide an optimal treatment to the liking of the user.

With the present invention pressure sensing can, of course, only be performed while an actuator is active. To avoid that there will be many moments in time in which pressure cannot be sensed (e.g. because some actuators will be off most of the time in practical applications), it is proposed in an embodiment to provide very short actuator actuations (<150 ms), i.e. to switch said actuators on for a very short time, or to provide very soft actuations, which can barely be felt by users, so that during such short times or soft actuations the pressure sensing can be performed.

It should also be noted that a single measurement of pressure (from dominant frequency) can be subject to measurement error. In practices, it may be that the pressure cannot be very exactly determined due to mechanical variations in each individual actuator, and small variations in how the actuators are mounted in the haptic surface with materials. Therefore it is preferred in an embodiment to use multiple measurements from multiple actuators (preferably plus a model) to “smoothen out” these measurement errors, which increases reliability of the estimation process.

As explained above, to obtain information about the pressure exerted onto the respective actuators various characteristics of the sensed actuator current signals and/or the sensed actuator voltage signals may exploited. In particular, the amount of the current drawn by the actuators and/or the amount of the voltage applied to the actuators may be exploited. Alternatively or in addition, the phase and/or frequency of the small current variation signal or small voltage variation signal may be exploited. Preferably, the dominant frequency in said actuator current or voltage signals are used for this purpose.

The present invention can be applied for various purposes and in various types of devices, in particular where a haptic effect shall be provided through multiple haptic actuators. Preferred applications include:

Relaxation or massage products incorporating multi-actuator haptic surfaces, including consumer products and solutions for hospitality business;

Relaxation/meditation training systems incorporating multi-actuator haptic surfaces;

TV/home cinema entertainment system incorporating multi-actuator haptic surfaces;

Breathing guidance systems incorporating multi-actuator haptic surfaces, including solutions for healthcare environments, consumer products, (consumer) products for falling asleep faster.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A device (20) for providing haptic effects on a haptic surface, said device comprising:
a haptic surface (22),
a number of haptic actuators (24) provided in or close to the haptic surface,
a control means (26) for controlling said haptic actuators to provide a haptic effect in their proximity on the haptic surface,
a sensing means (28) for sensing the actuator current and/or actuator voltage per actuator or group of actuators,
a processing means (30) for processing the sensed actuator current signals and/or actuator voltage signals by separately determining a characteristic of said actuator current signals and/or actuator voltage signals and generating pressure indications from the determined characteristic, said pressure indications indicating the amount of pressure at the respective actuator or group of actuators.

2. The device as claimed in claim 1,
wherein said processing means (30) is adapted for determining a dominant frequency in said actuator current signals and/or actuator voltage signals and generating said pressure indications from the determined dominant frequencies.

3. The device as claimed in claim 1,
wherein said processing means (30) is adapted for determining the frequency spectra of the sensed actuator current signals and/or actuator voltage signals, finding a maximum peak in said frequency spectra in a predetermined frequency range and generating said pressure indications from said maximum peaks, wherein the amount of pressure is assumed to be higher the higher the frequency of a maximum peak is.

4. The device as claimed in claim 1,
wherein said processing means (30) is adapted for determining that an object is exerting pressure on said haptic surface by determining if the percentage of actuators, whose pressure indications indicate an amount of pressure above a predetermined pressure threshold, is above a predetermined actuator threshold.

5. The device as claimed in claim 1,
wherein the processing means (30) is adapted for determining the position, orientation and/or pose of an object exerting pressure on said haptic surface, in particular being positioned on the haptic surface.

6. The device as claimed in claim 1,
wherein said processing means (30) is adapted for determining the position, orientation and/or pose of an object exerting pressure on said haptic surface by use of a model representing the object.

7. The device as claimed in claim 1,
wherein said sensing means (28) includes a comparator for comparing an actual actuator current or voltage, respectively, with a reference current or voltage, respectively, and for issuing the difference as said actuator current signal or actuator voltage signal, respectively.

8. The device as claimed in claim 1,
wherein said control means (26) is adapted for controlling selected or all actuators sequentially or in groups in parallel to provide a haptic effect.

9. The device as claimed in claim 1,
wherein said control means (26) is adapted for subsequently controlling actuators to provide a haptic effect, at which it is known or suspected that an object exerts pressure on said haptic surface in the proximity to said actuator.

10. The device as claimed in claim 1,
wherein said control means (26) is adapted for controlling actuators to provide a haptic effect based on knowledge about the shape and/or position of an object exerting pressure on said haptic surface.

11. The device as claimed in claim 10,
wherein said control means (26) is adapted for controlling actuators to provide a haptic effect only at positions where parts of the object, in particular significant parts of the object, are assumed to be positioned and wherein the processing means is adapted for estimating the position, orientation and/or pose of the other parts of the object.

12. The device as claimed in claim 1,
wherein said processing means (30) is adapted for performing a predetermined number of pressure measurements, a predetermined sequence of pressure measurements and/or amounts of pressure at predetermined actuators and interpreting them as a command or information.

13. The device as claimed in claim 1,
wherein said device (20) is a relaxation or massage device, a relaxation or meditation training system, a TV or home cinema entertainment system or a breathing guidance system.

14. A method for providing haptic effects on a haptic surface, said method comprising the steps of:
providing haptic effects on a haptic surface by use of a number of haptic actuators provided in or close to the haptic surface,
controlling said haptic actuators to provide a haptic effect in their proximity on the haptic surface,
sensing the actuator current and/or actuator voltage per actuator or group of actuators,
processing the sensed actuator current signals and/or actuator voltage signals by separately determining a characteristic of said actuator current signals and/or actuator voltage signals and generating pressure indications from the determined characteristic, said pressure indications indicating the amount of pressure at the respective actuator or group of actuators.

15. Computer program comprising program code means for controlling a device as claimed in claim 1 to carry out, when said computer program is carried out, the steps of
controlling said haptic actuators to provide a haptic effect in their proximity on the haptic surface,
sensing the actuator current and/or actuator voltage per actuator or group of actuators,
processing the sensed actuator current signals and/or actuator voltage signals by separately determining a characteristic of said actuator current signals and/or actuator voltage signals and generating pressure indications from the determined characteristic, said pressure indications indicating the amount of pressure at the respective actuator or group of actuators.
